(19) United States
(12) Patent Application Publication
(10) Pub. No.: US 2013/0288028 A1
(43) Pub. Date: Oct. 31, 2013

(54) METHOD FOR SURFACE TREATING PLASTIC PRODUCTS AND PLASTIC PRODUCTS MADE THEREBY

(71) Applicants: QUAN ZHOU, Shenzhen City (CN); GUI-YUN YANG, Shenzhen City (CN); XIN-WU GUAN, Shenzhen City (CN)

(72) Inventors: QUAN ZHOU, Shenzhen City (CN); GUI-YUN YANG, Shenzhen City (CN); XIN-WU GUAN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/614,635

(22) Filed: Sep. 13, 2012

(30) Foreign Application Priority Data
Apr. 28, 2012 (CN) 201210128852.X

(51) Int. Cl. B32B 27/36; B05D 3/12; B32B 27/40

(52) U.S. Cl. 428/213; 428/480; 428/423.1; 427/270

(57) ABSTRACT

A method for surface treating plastic products includes providing a plastic substrate; forming a base paint layer on the plastic substrate; forming a flat paint layer on the base paint layer, the flat paint layer made of a flat paint and having an initial specular gloss at 60° geometry of about 5-10; partially masking the flat paint layer; and polishing unmasked portions of the flat paint layer to achieve a specular gloss at 60° geometry of about 80-90. A plastic product made by the present method is also described.

### BACKGROUND

1. Technical Field

The present disclosure relates to methods for surface treating plastic products, particularly to a method for surface treating plastic products by which the plastic products have an appearance of different levels of glossiness at different regions.

2. Description of Related Art

A method for creating an appearance of different levels of glossiness at different regions of a plastic product coated with paint includes sandblasting portions of the paint coating to decrease the glossiness thereof. However, the sandblasted portions easily attract dust and grease. Another method includes painting different regions of the plastic product with different paints having different levels of glossiness. However, the paint layers at different regions may have different thicknesses, contributing to a rough surface.

Therefore, there is room for improvement within the art.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings like reference numerals designate corresponding parts throughout the views.

FIG. 1 is a block diagram of a process for surface treating plastic products according to an exemplary embodiment.

FIG. 2 is a cross-sectional view of a plastic product made by the present method according to an exemplary embodiment.

### DETAILED DESCRIPTION

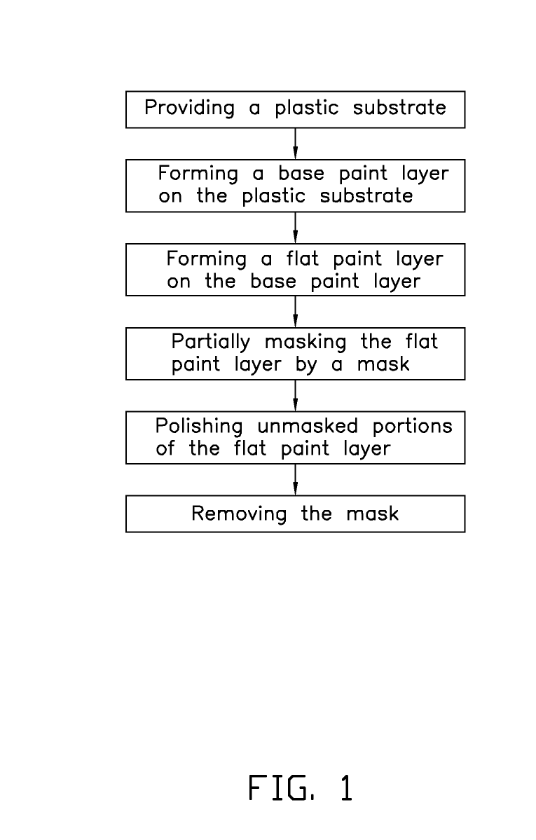

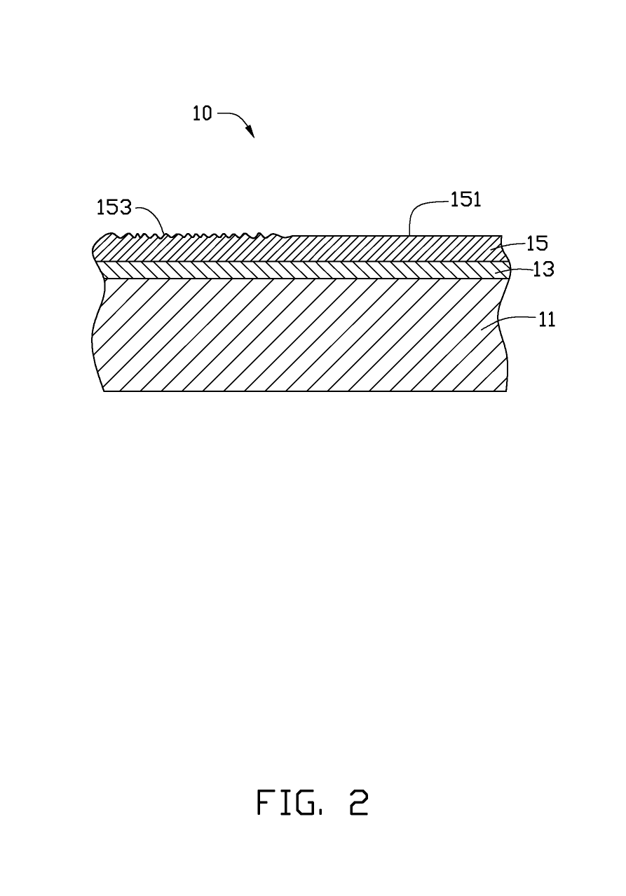

Referring to FIGS. 1-2, an exemplary method for surface treating plastic products may include the following steps.

A plastic substrate 11 is provided. The substrate 11 may be made of acrylonitrile-butadiene-styrene, polycarbonate, polyethylene, polyethylene terephthalate, or polymethyl methacrylate. The substrate 11 may be made by injection molding and have any desired shape.

A base paint layer 13 is formed on the substrate 11 by, for example spraying. The base paint layer 13 can be made from a transparent solvent paint, such as transparent polyacrylic resin paint. The base paint layer 13 decreases the surface roughness of the substrate 11 and improves the bonding strength of the subsequently formed layer(s).

A flat paint layer 15 is formed on the base paint layer 13 by, for example spraying. The flat paint layer 15 is made of a flat paint (also known as matt paint which dries to a minimally reflective finish), such as an acrylic polyurethane flat paint containing acrylic resin, pigment, delustering agent, and plasticizer. The flat paint layer 15 has an initial specular gloss at 60° geometry of about 5-10. The initial thickness of the flat paint layer 15 is about 35 μm to about 45 μm.

The flat paint layer 15 is partially masked by a mask. A metal mask or adhesive tape may be used to partially mask the flat paint layer 15.

Unmasked portions of the flat paint layer 15 are polished to achieve a specular gloss at 60° geometry of about 80-90. As such, the unmasked portions of the flat paint layer 15 will have a glossy appearance and the masked portions of the flat paint layer 15 will have a matte appearance. A wool felt polishing wheel and a liquid polishing agent are used for polishing the flat paint layer 15. The polishing decreases the thickness of the polished portions by about 5 μm to about 10 μm. Thus, no obvious thickness difference exists between different portions of the flat paint layer 15 with different levels of gloss.

The mask is removed, obtaining a plastic product having an appearance of different levels of glossiness at different regions.

FIG. 2 shows an exemplary plastic product 10 made by the present method. The plastic product 10 includes the plastic substrate 11, the base paint layer 13 formed on the substrate 11, and the flat paint layer 15 formed on the base paint layer 13. The flat paint layer 15 has first portions 151 and second portions 153 adjacent to the first portions 151. The first portions 151 have a specular gloss at 60° geometry of about 80-90. The second portions 153 have a specular gloss at 60° geometry of about 5-10. The thickness of the first portions 151 is about 35 μm to about 45 μm. The thickness of the second portions 153 is about 5 μm to about 10 μm smaller than the thickness of the first portions 151. The base paint layer 13 can be made from a transparent solvent paint. The flat paint layer 15 is made of a flat paint, such as an acrylic polyurethane flat paint.

However, even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for surface treating plastic products, comprising:
providing a plastic substrate;
forming a base paint layer on the plastic substrate;
forming a flat paint layer on the base paint layer, the flat paint layer made of a flat paint and having an initial specular gloss at 60° geometry of about 5-10;
partially masking the flat paint layer; and
polishing unmasked portions of the flat paint layer to achieve a specular gloss at 60° geometry of about 80-90.

2. The method as claimed in claim 1, wherein the base pain layer is made from a transparent solvent paint.

3. The method as claimed in claim 2, wherein the base pain layer is made from transparent polyacrylic resin paint.

4. The method as claimed in claim 1, wherein the flat paint layer is made from an acrylic polyurethane flat paint containing acrylic resin, pigment, delustering agent, and plasticizer.

5. The method as claimed in claim 1, wherein partially masking the flat paint layer uses a metal mask.

6. The method as claimed in claim 1, wherein partially masking the flat paint layer uses an adhesive tape.

7. The method as claimed in claim 1, wherein the polishing causes the thickness of the polished portions to decrease by about 5 μm to about 10 μm.

8. The method as claimed in claim 1, wherein the polishing uses a wool felt polishing wheel and a liquid polishing agent.

9. A plastic product, comprising:
a plastic substrate;
a base paint layer formed on the plastic substrate; and
a flat paint layer made of a flat paint formed on the base paint layer, the flat paint layer having first portions and second portions adjacent to the first portions, the first portions having a specular gloss at 60° geometry of about 80-90, the second portions having a specular gloss at 60° geometry of about 5-10.

10. The device housing as claimed in claim 9, wherein the base pain layer is made from a transparent solvent paint.

11. The device housing as claimed in claim 10, wherein the base pain layer is made from transparent polyacrylic resin paint.

12. The device housing as claimed in claim 9, wherein the flat paint layer is made from an acrylic polyurethane flat paint containing acrylic resin, pigment, delustering agent, and plasticizer.

13. The device housing as claimed in claim 9, wherein the thickness of the second portions is about 5 μm to about 10 μm smaller than the thickness of the first portions.
